(19) United States
(12) Patent Application Publication
(10) Pub. No.: US 2011/0314510 A1
(43) Pub. Date: Dec. 22, 2011

(54) SET-TOP BOX AND ENTERTAINMENT SYSTEM USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/872,590

(22) Filed: Aug. 31, 2010

(30) Foreign Application Priority Data
Jun. 18, 2010 (CN) 201010203301.6

(51) Int. Cl. H04N 7/173

(52) U.S. Cl. 725/133

(57) ABSTRACT

An entertainment system includes a television and a set-top box. The set-top box is configured to receive television signals, convert the television signals to signals which can be reproduced on the television, and output the converted signals to the television. The set-top box includes a storage unit storing at least one game application and a processing unit configured to run the at least one game application to generate game video/audio signals which are displayed on the television. A related set-top box is also provided.

### BACKGROUND

1. Technical Field

The present disclosure relates to set-top boxes and entertainment systems, and particularly to a set-top box capable of running game applications and a entertainment system using the set-top box.

2. Description of Related Art

A set-top box is used to receive digital television signals and convert the digital television signals into signals which can be displayed on a television communicating with the set-top box. However, a conventional set-top box cannot provide other entertainment except television programs. This is very limited and can be inconvenient for users.

Therefore, there is room for improvement in the art.

### BRIEF DESCRIPTION OF THE DRAWINGS

The components of the drawings are not necessarily drawn to scale, the emphasis instead being placed upon clearly illustrating the principles of a set-top box and a entertainment system using the same. Moreover, in the drawings, like reference numerals designate corresponding parts throughout several views.

FIG. 1 is a schematic view of an entertainment system in accordance with an exemplary embodiment.

FIG. 2 is a block diagram of the entertainment system of FIG. 1 in accordance with an exemplary embodiment. The entertainment system includes a television and a set-top box with a processing unit.

FIG. 3 is a further block diagram of the processing unit of FIG. 2 in accordance with an exemplary embodiment.

### DETAILED DESCRIPTION

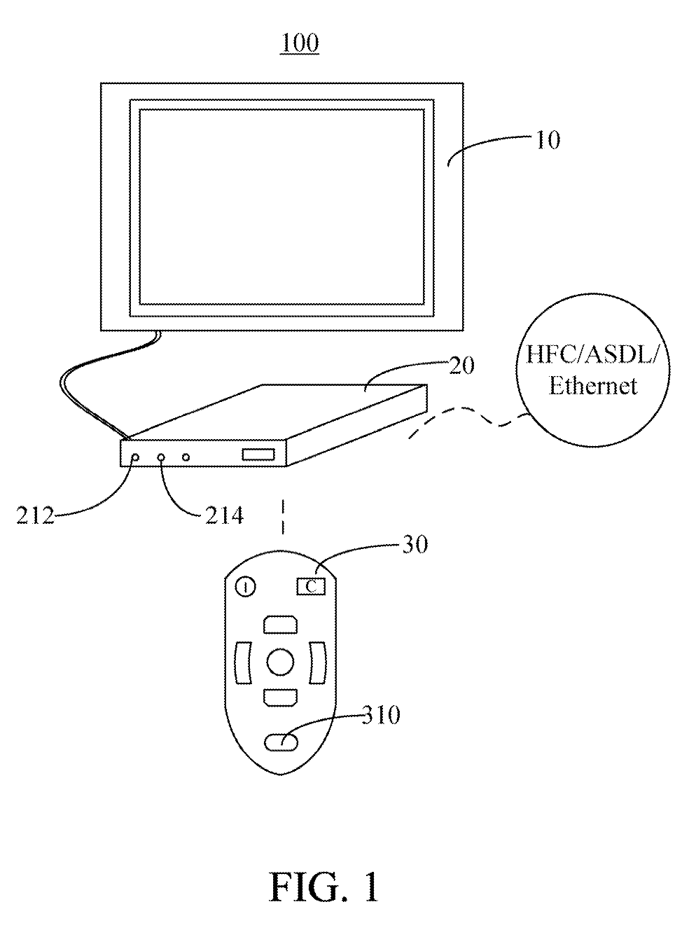

Referring to FIG. 1, an embodiment of an entertainment system 100 is illustrated. The system 100 includes a television 10, a set-top box 20 connected to the television 10, and a remote control device 30 configured to remotely control the set-top box 20. In this embodiment, the remote control device 30 communicates with the set-top box 20 through a wireless system.

In this embodiment, the set-top box 20 includes a television mode and a game mode. Under the television mode, the set-top box 20 receives television signals from a television broadcast terminal (not shown), and converts the received television signals into signals which can be reproduced on the television 10, and the remote control device 30 is employed to control the television, for example, changing the channels. Under the game mode, the set-top box 20 runs game applications to generate game video/audio signals, which can be displayed on the television 10, and the remote control device 30 is employed to control game playing.

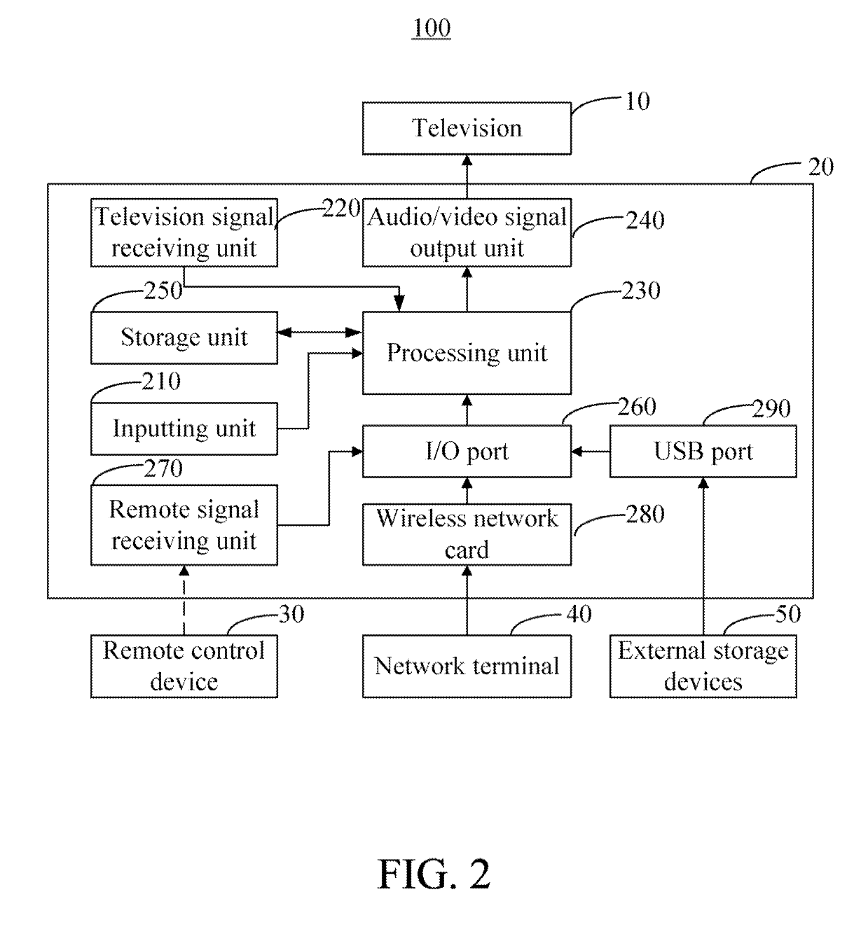

Referring to FIG. 2, the set-top box 20 includes an input unit 210, a television signal receiving unit 220, a processing unit 230, an audio/video signal output unit 240, a storage unit 250, an I/O port 260, and a remote signal receiving unit 270. The input unit 210, the television signal receiving unit 220, the audio/video signal output unit 240, the storage unit 250, and the I/O port 260 are electrically connected to the processing unit 230 with data buses. The remote signal receiving unit 270 is connected to the processing unit 230 through the I/O port 260.

The input unit 210 at least includes a control button 212 (see FIG. 1) and a switch button 214. The control button 212 is configured to generate control signals to control the set-top box 20 in response to user input, for example, adjust property parameters of the set-top box 20. The switch button 214 is configured to generate switch signals for switching the set-top box 20 between the television mode and the game mode in response to user input.

The storage unit 250 is configured to store multimedia files, for example, game applications.

The television signal receiving unit 220 is configured to receive television signals.

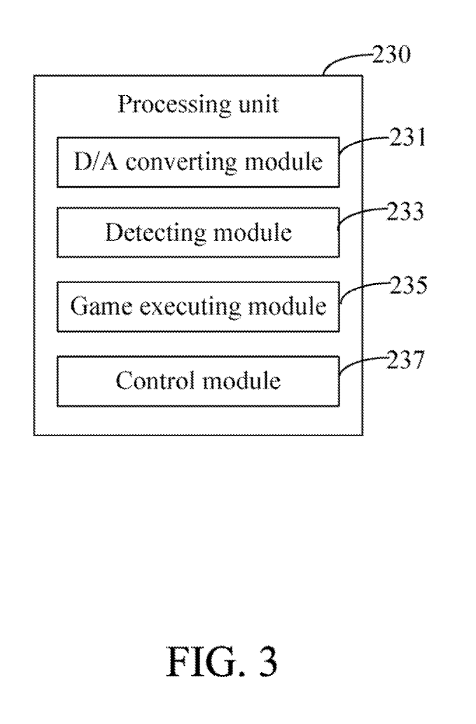

Referring also to FIG. 3, the processing unit 230 includes a D/A converting module 231, a detecting module 233, a game executing module 235, and a control module 237.

The detecting module 233 is configured to detect whether a switch signal is generated by the switch button 214, and generate a first detect signal if the switch signal is generated. The control module 237 is configured to switch the set-top box 20 between the television mode and the game mode according to the first detect signal. Specifically, if the current mode is the television mode, the control module 237 switches the set-top box 20 from the television mode to the game mode upon receiving the first detect signal. If the current mode is the game mode, the control module 237 switches the set-top box from the game mode to the television mode upon receiving the first detect signal.

The D/A converting module 231 is configured to convert the television signals received by the television signal receiving unit 220 to signals which can be reproduced on the television 10 when the set-top box 20 is in the television mode. The audio/video signal output module 240 is configured to output the converted signals to the television 10, thus television programs can be displayed on the television 10.

The game executing module 235 is configured to execute stored game applications to generate game audio/video signals when the set-top box 20 is in the game mode. The audio/video signal output module 240 is further configured to output the game audio/video signals to the television 10, thus, games can be displayed on the television 10.

In this embodiment, the remote control device 30 includes a switch button 310 configured to generate switch signals for switching the set-top box 20 between the television mode and the game mode. When the detecting module 233 detects that the switch signals from the switch button 310 have been generated, the detecting module 233 generates a second detect signal. The control module 237 can switch the set-top box 20 between the television mode and the game mode according to the second detect signal.

The set-top box 20 further includes a wireless network card 280 and a USB port 290. The card 280 and the USB port 290 are electrically connected to the processing unit 230 through the I/O port 260. The set-top box 20 communicates with a network terminal 40 through the wireless network card 280, thus the set-top box 20 can download information, for example, game applications, from Internet. The set-top box 20 can be connected to external storage devices 50, for example, hard disks, through the USB port 290, and can read files from the external storage devices 50. Therefore, the files stored in the storage unit 250 can be updated through the Internet and/or the external storage devices 50.

With such configuration, users can play games through the set-top box 20, it will bring more entertainment value to users.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An entertainment system, comprising:
a television; and
a set-top box configured to receive television signals, convert the 1 television signals to signals which can be reproduced on the television, and output the converted signals to the television, the set-top box comprising:
a storage unit storing at least one game application; and
a processing unit configured to run the at least one game application to generate game video/audio signals which can be displayed on the television.

2. The entertainment system as described in claim 1, wherein the set-top box further comprises a television signal receiving unit and a video/audio output unit, the television signal receiving unit is configured to receive the 1 television signals, and the video/audio output unit is configured to output the signals which can be reproduced on the television to the television.

3. The entertainment system as described in claim 1, wherein the set-top box further comprises a switch button, the switch button is configured to generate switch signals for switching the set-top box between a television mode and a game mode in response to user input, and the processing unit is further configured to switch the set-top box between the television mode and the game mode according to the switch signals.

4. The entertainment system as described in claim 3, wherein the processing unit comprises a detecting module and a control module, the detecting module is configured to generate a detect signal upon detecting the switch signals from the switch button, and the control module is configured to switch the set-top box between the television mode and the game mode according to the detect signal.

5. The entertainment system as described in claim 2, wherein the processing unit further comprises a D/A converting module configured to convert the television signals to the signals which can be reproduced on the television.

6. The entertainment system as described in claim 2, wherein the processing unit further comprises a game executing module configured to run the at least one game application to generate the game video/audio signals, the video/audio output module is further configured to output the game video/audio signals to the television.

7. The entertainment system as described in claim 1, wherein the set-top box further comprises a wireless network card configured to connect the set-top box to a wireless network.

8. The entertainment system as described in claim 1 further comprising a remote control device, wherein the set-top box comprises a television mode and a game mode, the remote control device is configured to remotely control the television when the set-top box is in the television mode, and configured to control game playings when the set-top box is in the game mode.

9. The entertainment system as described in claim 8, wherein the remote control device comprises a switch button configured to generate switching signals for switching the set-top between the television mode and the game mode.

10. A set-top box, comprising:
a switch button configured to generate switch signals for switching the set-box between a television mode and a game mode;
a storage unit storing at least one game application;
a television signal receiving unit configured to receive television signals and convert the 1 television signals to signals which can be reproduced on the television when the set-top box is in the television mode;
a processing unit configured to run the at least one game application of the storage unit to generate game video/audio signals when the set-top box is in the game mode;
a video/audio output module configured to output the converted signals to a television connected to the set-top box when the set-top box is in the television mode, and further configured to output the game video/audio signals to the television when the set-top box is in the game mode.

11. The set-top box according to claim 10, wherein the processing unit comprising:
a D/A converting module configured to convert the television signals to the signals which can be reproduced on the television when the set-top box is in the television mode;
a detecting module configured to generate a detect signal upon detecting the switch signals from the switch button;
a control button configured to switch the set-top box between the television mode and the game mode according to the detect signal; and
a game executing module configured to run the at least one game application to generate game video/audio signals in response to user input when the set-top box is in the game mode.
